(19) United States
(12) Patent Application Publication
(10) Pub. No.: US 2022/0005231 A1
(43) Pub. Date: Jan. 6, 2022

(54) A METHOD AND DEVICE FOR ENCODING / RECONSTRUCTING 3D POINTS

(71) Applicant: InterDigital VC Holdings, Inc., Wilmington, DE (US)

(72) Inventors: Julien Ricard, Plouer-sur-Rance (FR); Celine Guede, Cesson-Sevigne (FR); Joan Llach, London (GB)

(21) Appl. No.: 17/282,496

(22) PCT Filed: Oct. 4, 2019
(86) PCT No.: PCT/US2019/054616

§ 371 Date: Apr. 2, 2021

(30) Foreign Application Priority Data
Oct. 5, 2018 (FR) 18306317.1
Oct. 9, 2018 (FR) 18306334.6

(51) Int. Cl. G06T 9/00; G06T 17/20; G06K 9/62

(52) U.S. Cl. CPC G06T 9/001; G06K 9/6202; G06T 17/205

(57) ABSTRACT

The present embodiments relate to a method for encoding 3D points whose geometry is represented by geometry images and attribute is represented by an attribute image. The method checks whether the depth value of a pixel in a first of said geometry images and the depth value of a co-located pixel in a second of said geometry images are not the same (not identical values). When the depth value of a pixel in said first geometry image and the depth value of the co-located pixel in said second geometry image are not the same, then the method assigns (encodes), attribute of a 3D point defined from 2D spatial coordinates of said pixel in said first geometry image and the depth value of said co-located pixel in the second geometry image.

### FIELD

The present embodiments generally relate to coding and reconstructing of 3D points. Particularly, but not exclusively, the technical field of the present embodiments are related to encoding/reconstructing of a point cloud representing the external surface of a 3D object.

### BACKGROUND

The present section is intended to introduce the reader to various aspects of art, which may be related to various aspects of the present embodiments that are described and/or claimed below. This discussion is believed to be helpful in providing the reader with background information to facilitate a better understanding of the various aspects of the present embodiments. Accordingly, it should be understood that these statements are to be read in this light, and not as admissions of prior art.

A point cloud is a set of data points in some coordinate system. In a three-dimensional coordinate system (3D space), these points are usually intended to represent the external surface of a 3D object. Each point of a point cloud is often defined by its location (X, Y, and Z coordinates in the 3D space) and possibly by other associated attributes such as a color, represented in the RGB or YUV color space for example, a transparency, a reflectance, a two-component normal vector, etc.

It is usual to represent a point cloud as a set of 6-components points (X, Y, Z, R, G, B) or equivalently (X, Y, Z, Y, U, V) where (X,Y,Z) defines the coordinates of a colored point in a 3D space and (R,G,B) or (Y,U,V) defines a color of this colored point.

Point clouds may be static or dynamic depending on whether or not the cloud evolves with respect to time. It should be noticed that in case of a dynamic point cloud, the number of points is not constant but, on the contrary, generally evolves with time. A dynamic point cloud is thus a time-ordered list of set of points.

Practically, point clouds may be used for various purposes such as culture heritage/buildings in which objects like statues or buildings are scanned in 3D in order to share the spatial configuration of the object without sending or visiting it. Also, it is a way to ensure preserving the knowledge of the object in case it may be destroyed; for instance, a temple by an earthquake. Such point clouds are typically static, colored and huge.

Another use case is in topography and cartography in which using 3D representations, maps are not limited to the plane and may include the relief. Google Maps is now a good example of 3D maps but uses meshes instead of point clouds. Nevertheless, point clouds may be a suitable data format for 3D maps and such point clouds are typically static, colored and huge.

Automotive industry and autonomous car are also domains in which point clouds may be used. Autonomous cars should be able to “probe” their environment to take good driving decision based on the reality of their immediate neighboring. Typical sensors like LIDARs produce dynamic point clouds that are used by the decision engine. These point clouds are not intended to be viewed by a human being and they are typically small, not necessarily colored, and dynamic with a high frequency of capture. They may have other attributes like the reflectance provided by the Lidar as this attribute is a good information on the material of the sensed object and may help the decision.

Virtual Reality and immersive worlds have become a hot topic recently and foreseen by many as the future of 2D flat video. The basic idea is to immerse the viewer in an environment all round him by opposition to standard TV where he can only look at the virtual world in front of him. There are several gradations in the immersivity depending on the freedom of the viewer in the environment. Colored point cloud is a good format candidate to distribute Virtual Reality (or VR) worlds. They may be static or dynamic and are typically of averaged size, say no more than millions of points at a time.

Point cloud compression will succeed in storing/transmitting 3D objects for immersive worlds only if the size of the bitstream is low enough to allow a practical storage/transmission to the end-user.

It is crucial to be able to distribute dynamic point clouds to the end-user with a reasonable consumption of bitrate while maintaining an acceptable (or preferably very good) quality of experience. Efficient compression of these dynamic point clouds is a key point in order to make the distribution chain of immersive worlds practical.

Image-based point cloud compression techniques are becoming increasingly popular due to their combination of compression efficiency and low complexity. They proceed in two main steps: first, they project (orthogonal projection) the point cloud, i.e. the 3D points, onto at least one 2D image plan. For example, at least one 2D geometry (also denoted depth) image is thus obtained to represent the geometry of the point cloud, i.e. the spatial coordinates of the 3D points in a 3D space, and at least one 2D attribute (also denoted texture) image is also obtained to represent an attribute associated with the 3D points of the point cloud, e.g. a texture/color information associated to those 3D points. Next, these techniques encode such geometry and attribute images into at least one geometry and attribute layers with legacy video encoders.

Image-based point cloud compression techniques achieve good compression performance by leveraging the performance of 2D video encoder, like for example HEVC (“ITU-T H.265 Telecommunication standardization sector of ITU (10/2014), series H: audiovisual and multimedia systems, infrastructure of audiovisual services—coding of moving video, High efficiency video coding, Recommendation ITU-T H.265”), while at the same time, they keep complexity low by using simple projection schemes.

One of the challenges of image-based point cloud compression techniques is that a point cloud may not be suitable for projection onto images, especially when the point distribution follows a surface with many folds (concave/convex regions, like in clothing) or when the point distribution does not follow a surface at all (like in fur or hair). In these situations, image-based point cloud compression techniques suffer from low compression efficiency (many small projections are required, reducing the efficiency of the 2D video compression) or bad quality (due to the difficulty of projecting the point cloud onto a surface).

One of the approaches used in the state of the art to alleviate this problem consists in projecting multiple geometry and attribute information onto a same spatial location of an image. This means that several geometry and/or attribute images may be generated per 3D point of the point cloud having the same projection coordinates (same 2D spatial coordinates of a pixel).

This is the case, for example, of the so-called Test Model Category 2 point cloud encoder (TMC2) as defined in ISO/IEC JTC1/SC29/WG11 MPEG2018/N17767, Ljubljana, July 2018 (Appendix A) in which the point cloud is orthogonally projected onto a projection plane. Two geometry images are generated per coordinate of said projection plane: one representative of the depth value associated with the nearest point (smallest depth value) and another representative of the depth value of the farthest point (largest depth value). A first geometry image is then generated from the smallest depth values (D0) and a second geometry image is generated from the absolute value of the largest depth value (D1) with D1-D0 lower than or equal to a maximum surface thickness. A first and second attribute images are also generated in association with the first (D0) and second (D1) geometry images. Both the attribute and geometry images are then encoded and decoded using any legacy video codec such as HEVC. The geometry of the point cloud is thus reconstructed by deprojection of information comprised in decoded first and second geometry images and attribute is associated with reconstructed 3D from information comprised in decoded attribute images.

A drawback of capturing two geometry (and two attribute) values is that two 3D points are systematically reconstructed from the two geometry images, creating thus duplicated reconstructed 3D points when the depth value of a pixel in a first geometry image equals to depth value of a co-located pixel in a second geometry image. Next, encoding unnecessary duplicated points increases the bit rate for transmitting the encoded set of 3D points. Moreover, computing and storing resources are also wasted both at the encoding and decoding side for handling such fake duplicated 3D points.

### SUMMARY

The following presents a simplified summary of the present embodiments in order to provide a basic understanding of some aspects of the present embodiments. This summary is not an extensive overview of the present embodiments. It is not intended to identify key or critical elements of the present embodiments. The following summary merely presents some aspects of the present embodiments in a simplified form as a prelude to the more detailed description provided below.

The present embodiments set out to remedy at least one of the drawbacks of the prior art with a method and an apparatus for encoding 3D points whose geometry is represented by geometry images and attribute is represented by an attribute image. When the depth value of a pixel in a first of said geometry images and the depth value of a co-located pixel in a second of said geometry images are not the same, the method assigns to a co-located pixel of said attribute image, an attribute of a 3D point whose geometry is defined from 2D spatial coordinates of a co-located pixel in said first geometry image and the depth value of said co-located pixel in said second geometry image.

According to an embodiment, the method further comprises assigning a dummy attribute to a pixel of said attribute image when the depth value of a co-located pixel in said first geometry image and the depth value of a co-located pixel in said second geometry image are the same.

According to an embodiment, the dummy attribute is the attribute of the co-located pixel of another attribute image.

According to an embodiment, the dummy attribute is an average of attributes associated with neighboring pixels located around said pixel.

According to an embodiment, the method further comprises transmitting an information data indicating if the depth value of a pixel in said first geometry image and the depth value of a co-located pixel in said second geometry image are compared or not before reconstructing a 3D point from said geometry images.

According to another of their aspects, the present embodiments relate to a bitstream carrying encoded attributes of 3D points being structured as multiples blocks, patches of blocks and frames of patches, wherein said information data is valid at a group of frame level, at frame level, at patch level or at block level.

According to another of their aspects, the present embodiments relate a method for reconstructing 3D points from geometry images representing the geometry of said 3D points, wherein the method comprises reconstructing a 3D point from 2D spatial coordinates of a pixel in a first of said geometry images and the depth value of a co-located pixel in a second of said geometry images when the depth value of said pixel in said first geometry image and the depth value of said co-located pixel in said second depth image are not the same.

According to an embodiment, the method further comprises receiving an information data indicating if the depth value of a pixel in said first geometry image and the depth value of a co-located pixel in said second geometry image are compared or not before reconstructing a 3D point from said geometry images.

According to an embodiment, a bitstream carrying encoded attributes of 3D points being structured as multiples blocks, patches of blocks and frames of patches, then said information data is valid at a group of frame level, at frame level, at patch level or at block level.

According to an embodiment, an attribute of a 3D point is a color value or a texture value.

One or more of at least one of embodiment also provide an apparatus, a computer program product, a non-transitory computer readable medium and a bitstream.

The specific nature of the present embodiments as well as other objects, advantages, features and uses of the present embodiments will become evident from the following description of examples taken in conjunction with the accompanying drawings.

### BRIEF DESCRIPTION OF DRAWINGS

In the drawings, examples of the present embodiments are illustrated. It shows:

FIG. 1 shows schematically a diagram of the steps of a method 100 for encoding attributes associated with 3D points in accordance with an example of the present embodiments;

FIG. 2 shows schematically a diagram of the steps of a method 200 for reconstructing 3D points from geometry images representing the geometry of said 3D points in accordance with an example of the present embodiments.

FIG. 3 shows schematically the method for encoding the geometry and attribute of a point cloud as defined in TMC2;

FIG. 4 shows schematically the method for decoding the geometry and attribute of a point cloud as defined in TMC2;

FIG. 5 illustrates a block diagram of an example of a system in which various aspects and embodiments are implemented;

FIG. 6 shows an example a syntax element “group_of_frames_header( )” of TCM2 amended in accordance with the present embodiments;

FIG. 7-7b show an example a syntax element denoted “frame_auxiliary_information(frame_index)” of TCM2 and amended in accordance with the present embodiments; and

FIG. 8-8b show another example a syntax element denoted “frame_auxiliary_information(frame_index)” of TCM2 and amended in accordance with the present embodiments.

Similar or same elements are referenced with the same reference numbers.

### DESCRIPTION OF EXAMPLE OF THE PRESENT EMBODIMENTS

The present embodiments will be described more fully hereinafter with reference to the accompanying figures, in which examples of the present embodiments are shown. The present embodiments may, however, be embodied in many alternate forms and should not be construed as limited to the examples set forth herein. Accordingly, while the present embodiments are susceptible to various modifications and alternative forms, specific examples thereof are shown by way of examples in the drawings and will herein be described in detail. It should be understood, however, that there is no intent to limit the present embodiments to the particular forms disclosed, but on the contrary, the specification is to cover all modifications, equivalents, and alternatives falling within the spirit and scope of the present embodiments as defined by the claims.

The terminology used herein is for the purpose of describing particular examples only and is not intended to be limiting of the present embodiments. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present embodiments.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present embodiments. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims.

While not explicitly described, the present examples and variants may be employed in any combination or sub-combination.

The present embodiments are described for encoding/reconstructing two geometry images and two attribute images representative of a point cloud but extends to the encoding/reconstructing of two sequences (video) of geometry images and two sequences (video) of attribute images representative of a sequence of point clouds (temporally dynamic point cloud) because the geometry (two geometry images) and attribute (texture/color) of a point cloud of the sequence of point clouds is then encoded/reconstructed independently of the geometry (two geometry images) and attribute (texture/color) of another point cloud of the sequence of point clouds.

Generally speaking, the present embodiments relate to a method for encoding attributes of 3D points whose geometry is represented by geometry images. Said 3D points may form a point cloud representing the external surface of a 3D object for example. But the method is not limited to the encoding of point cloud and extend to any other set of 3D points. The geometry (3D coordinates) of said 3D points is represented as geometry images.

The method checks whether the depth value of a pixel in a first of said geometry images and the depth value of a co-located pixel in a second of said geometry images are not the same (not identical values). When the depth value of a pixel in said first geometry image and the depth value of the co-located pixel in said second geometry image are not the same, then the method assigns (encodes), attribute of a 3D point defined from 2D spatial coordinates of said pixel in said first geometry image and the depth value of said co-located pixel in the second geometry image. Otherwise, the method assigns a dummy value as attribute of said 3D point.

The method thus modifies the usual geometry and attribute encoding of a set of 3D points by avoiding the encoding of fake duplicated 3D points as it happens, for example, in TMC2. This avoids wasting computing and storing resources at the encoding side and limits the bit rate to transmit encoded 3D points.

The present embodiments also relate to a method for reconstructing 3D points from geometry images representing the geometry of said 3D points.

The method checks whether the depth value of a pixel in a first of said geometry images and the depth value of a co-located pixel in a second of said geometry images are not the same. Then, the method reconstructs a 3D point from 2D spatial coordinates of said pixel in the first geometry image and the depth value of the co-located pixel in the second geometry image when the depth value of said pixel in the first geometry image and the depth value of said co-located pixel in the second depth image are not the same. Otherwise, no 3D point is reconstructed.

The method thus modifies the usual geometry and attribute reconstruction of 3D points by avoiding the creation of fake duplicated 3D points as it happens, for example, in TMC2. This avoids wasting computing and storing resources at the decoding side.

Examples of attribute extracted from an image may be a color, texture, normal vector, etc. . . . .

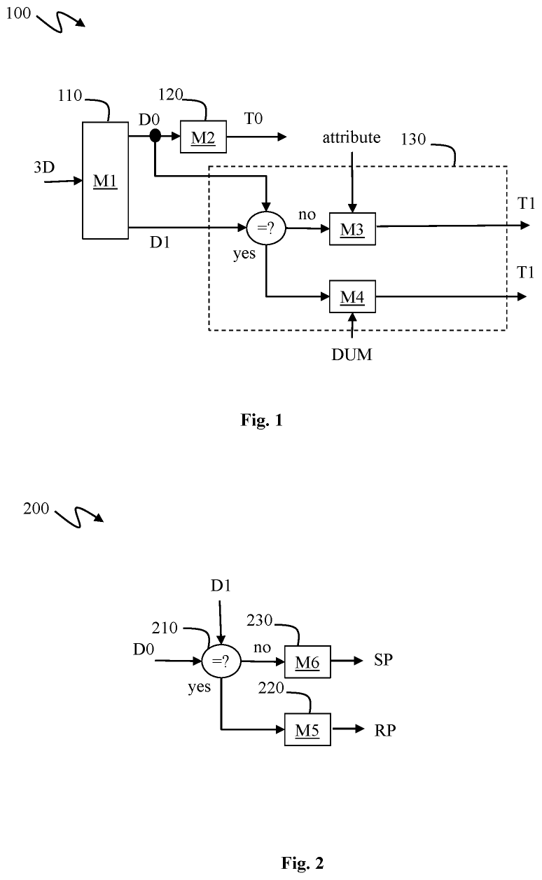

FIG. 1 shows schematically a diagram of the steps of a method 100 for encoding attributes of 3D points in accordance with an example of the present embodiments.

For example, said 3D points may form a point cloud but the method is not limited to point cloud and may apply to any set of 3D points.

In step 110, a module M1 may obtain geometry images representing the geometry of 3D points: Two of the three coordinates of said 3D points are represented by the 2D coordinates of pixels in the geometry images and the pixel values represent the third coordinates (depth values) of said 3D points.

For example, in TMC2, the 3D points may be orthogonally projected onto a projection plane and two geometry images D0 and D1 may be obtained from the depth values associated with said projected 3D points. D0 is the first geometry image that represents the depth values of the nearest 3D points of the projection plane and D1 is the second geometry image that represents the depth values of farthest 3D points. The geometry images may be encoded using for example a legacy image/video encoder such as HEVC.

In step 120, a module M2 may obtain a first attribute image, for example T0, representing attributes of 3D points RP defined from 2D spatial coordinates and depth values of pixels in a first geometry image D0 of said obtained geometry images.

For example, in TMC2, attributes of 3D points RP are obtained from the original 3D points (see section 2.5 of Appendix A for more details). The first attribute image T0 is encoded (not shown in FIG. 1) using for example a legacy image/video encoder such as HEVC.

In step 130, a module may obtain a second attribute image, for example T1. Said second attribute image T1 represents attributes of supplementary 3D points SP defined from 2D spatial coordinates of pixels in said first geometry image and depth values.

First, in step 130, a module compares the depth value of a pixel P in a first geometry image, for example D0, and the depth value of a co-located pixel CP in a second geometry image, for example D1. Next, when the depth value of said pixel P in the first geometry image D0 and the depth value of said co-located pixel CP in the second geometry image D1 are not the same, then a module M3 may assign to the co-located pixel in the second attribute image T1, an attribute of a 3D point whose geometry is defined from 2D spatial coordinates of said pixel P in said first geometry image and the depth value of said co-located pixel CP in said second geometry image. Otherwise, a module M4 may assign a dummy attribute DUM to the co-located pixel in the second attribute image.

The second attribute image T1 is encoded (not shown in FIG. 1) using for example a legacy image/video encoder such as HEVC.

According to an embodiment, the dummy attribute is the attribute of the co-located pixel of the first attribute image T0.

According to an embodiment, the dummy attribute is an average of attributes associated with neighboring pixels located around said pixel P.

FIG. 2 shows schematically a diagram of the steps of a method 200 for reconstructing 3D points from geometry images representing the geometry of said 3D points in accordance with an example of the present embodiments.

In step 210, a module may compare the depth value of a pixel P in a first of said geometry images, for example D0, and the depth value of a co-located pixel CP in a second of said geometry images, for example D1.

In step 220, a module M5 may define a 3D point RP from 2D spatial coordinates and depth values of the pixel P in the first geometry image D0.

In step 230, a module M6 defines a supplementary 3D point SP from 2D spatial coordinates of the pixel P of the first geometry image, for example D0, and the depth value of a co-located pixel CP in the second geometry image, for example D1, when the depth value of the pixel P in said first geometry image D0 and the depth value of said co-located pixel CP in said second geometry image D0 are not the same.

Attribute of a 3D point RP, defined from 2D spatial coordinates and depth values of a pixel in the first geometry image D0, is the value of a co-located pixel in a first attribute image T0. Attribute of a 3D point SP defined from 2D spatial coordinates of a pixel in the first geometry image D0, and the depth value of a co-located pixel in the second geometry image D1, is the value of a co-located pixel in a second attribute image T1 (value that is not equal to the dummy value DUM).

The method 100 encoding attributes of 3D points and, in particular, implements a first functionality that assigns (step 130) a dummy value to a pixel value in the second attribute image T1 when the depth value of the co-located pixel in the first geometry image D0 and the depth value of the co-located pixels in the second geometry image D1 are the same.

This first functionality thus limits the bit rate required to transmit attributes of 3D points and that reduces the computing and storing resources.

The method 200 reconstructs 3D points from geometry images representing the geometry of 3D points and, in particular, implements a second functionality that defines (step 230) a 3D point from 2D spatial coordinates of a pixel of a first of said geometry images and the depth value of a co-located pixel of a second of said geometry images, when the depth value of said pixel of said first geometry image and the depth value of said co-located pixel of said second geometry image are not the same.

According to a variant, said first and second functionalities are enabled when an information data ID represents a first value and disabled when said information data ID represents a second value. Thus, the information data ID indicates if the method 100 or 200 checks or not if the depth value of a pixel of a first geometry image and the depth value of said co-located pixel of a second geometry image are not the same before encoding an attribute of a 3D point (method 100) or before reconstructing a 3D point (method 200).

According to an embodiment, said first and second functionalities are enabled/disabled at a group of frame level.

An information data ID is then associated with a syntax element relative to a group of frames.

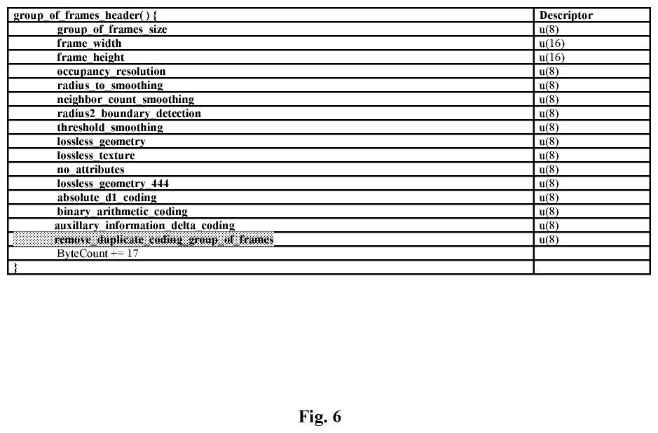

FIG. 6 shows an example a syntax element “group_of_frames_header( )” of TCM2 which includes a field denoted “remove_duplicate_coding_group_of_frames” representative of the information data ID associated with a group of frames.

This syntax element of FIG. 6 may be used for signaling the information data ID according to this embodiment.

According to an embodiment, said first and second functionalities are enabled/disabled at a group of frame level and at frame level.

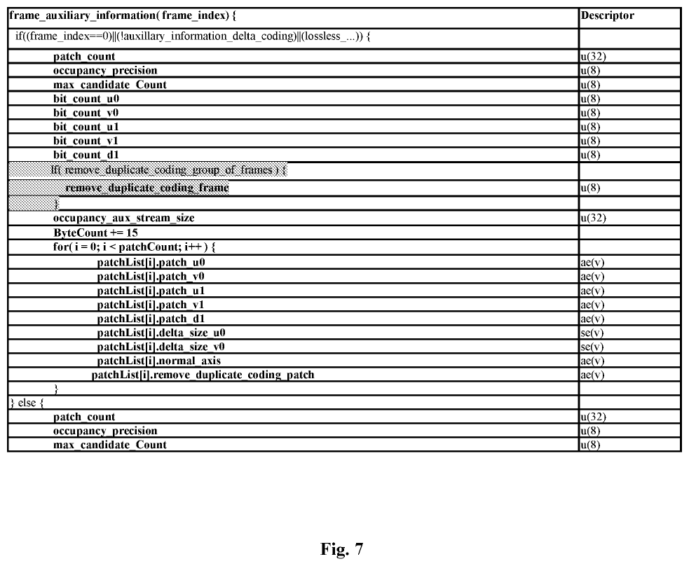

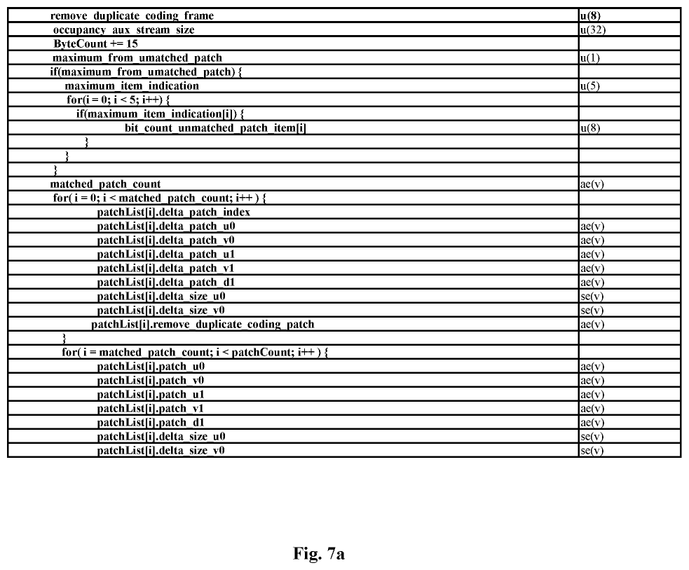

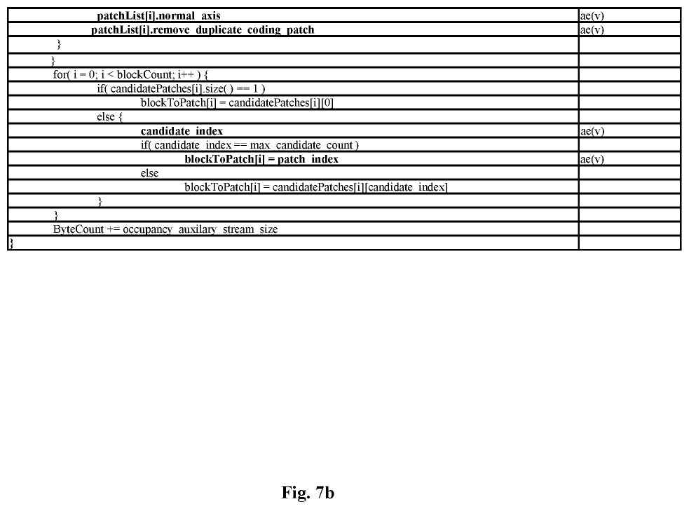

An information data ID is then associated with a syntax element relative to a group of frames, for example, the syntax element “group_of_frames_header( )” of TCM2 (FIG. 6) and an information data is also associated with a syntax element relative to a frame as shown in FIG. 7-7b.

FIG. 7 shows an example a syntax element denoted “frame_auxiliary_information(frame_index)” of TCM2 and amended as shown in FIGS. 7, 7a and 7b. (grey shaded areas).

The syntax element of FIG. 6 and this syntax element of FIG. 7-7b may be used for signaling the information data ID according to this embodiment.

According to an embodiment, said first and second functionalities are enabled/disabled at group of frame level, at frame level and at patch level. A patch may be defined as a part of an image.

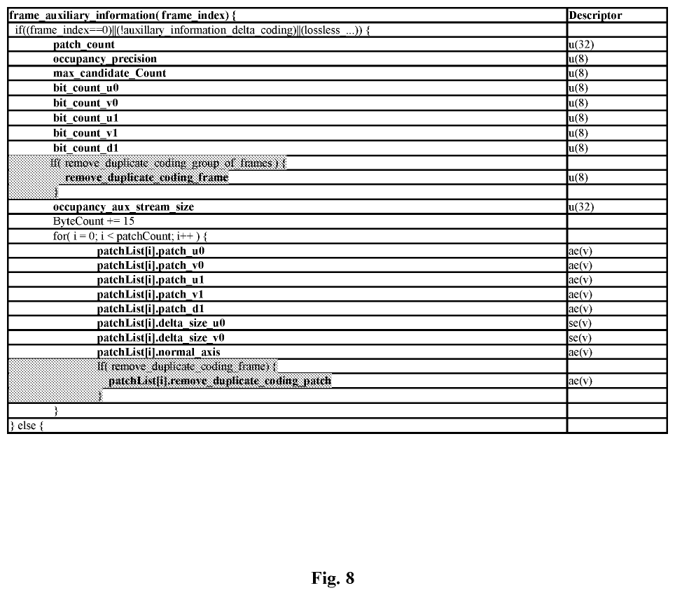

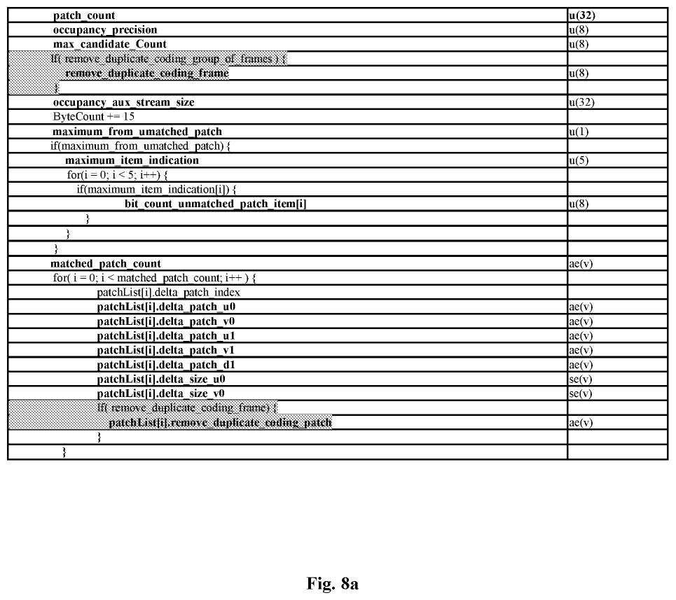

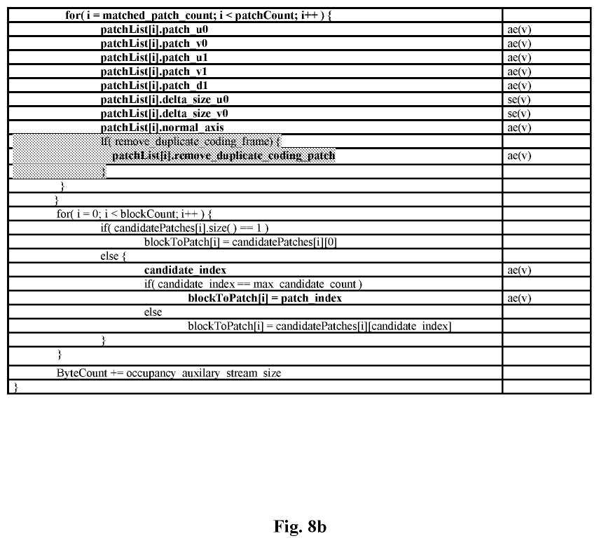

An information data ID is then associated with a syntax element relative to a group of frames, for example, the syntax element “group_of_frames_header( )” of TCM2 (FIG. 6), an information data is also associated with a syntax element relative to a frame as shown in FIG. 8-8b. FIG. 8 shows an example a syntax element denoted “frame_auxiliary_information(frame_index)” of TCM2 and amended as shown in FIGS. 8, 8a and 8b (grey shaded areas). The syntax element of FIG. 6 and this syntax element of FIG. 8-7b may be used for signaling the information data ID according to this embodiment.

According to a variant of said last embodiment, said first and second functionalities are enabled/disabled at frame block level.

For example, when a patch overlaps at least one image block, an information data ID may be signaled to indicate if the first and second functionalities are (or not) enabled for an image block.

This create dense 3D points at some part of a patch.

FIG. 3 shows schematically the method for encoding the geometry and attribute of a point cloud as defined in TMC2 (Appendix A).

Basically, the encoder captures the geometry information of the point cloud PC in a first (D0) and a second (D1) geometry images.

As an example, the first and second geometry images are obtained as follows in TMC2.

Geometry patches (set of 3D points of the point cloud PC) are obtained by clustering the points of the point cloud PC according to the normal vectors at these points. All the extracted geometry patches are then projected onto a 2D grid and packed while trying to minimize the unused space, and guaranteeing that every T×T (e.g., 16×16) block of the grid is associated with a unique patch, where T is a user-defined parameter that signaled into the bitstream.

Geometry images are then generated by exploiting the 3D to 2D mapping computed during the packing process, more specifically the packing position and size of the projected area of each patch. More precisely, let H(u,v) be the set of points of the current patch that get projected to the same pixel (u, v). A first layer, also called the nearest layer or the first geometry image D0, stores the point of H(u,v) with the smallest geometry value. The second layer, referred to as the farthest layer or the second geometry image D1, captures the point of H(u,v) with the highest geometry value within the interval [D, D+4], where D is a geometry value of pixels in the first geometry image D0 and 4 is a user-defined parameter that describes the surface thickness.

A first geometry image D0 then outputs the packing process. A padding process is also used to fill the empty space between patches in order to generate a piecewise smooth first geometry image suited for video compression.

The generated geometry images/layers D0 and D1 are then stored as video frames and compressed using any legacy video codec such as HEVC.

The encoder also captures the attribute information of the original point cloud PC in a two texture (attribute) images by encoding/decoding the first and second geometry images and reconstructing the geometry of the point cloud by deprojecting said decoded first and second geometry images \vec{D}₀, \vec{D}₁. Once reconstructed, a color is assigned (color transferring) to each point of the reconstructed point cloud from the color information of the original point cloud PC in a manner of minimizing color information coding error.

According to one embodiment, for each reconstructed point, the color of its nearest point in the original point cloud is assigned as its color to be coded.

A first and a second attribute images T0, T1 are then generated by storing the color information to be coded of each reconstructed point in the same position as in the geometry images, i.e. (i,u,v).

For example, the method 100 and 200 may be used at the encoding side of TMC2 (FIG. 1 of Appendix A) when a reconstructed point cloud is required, i.e. when the geometry and possibly the attribute of the point cloud is/are required. This is the case, for example, for generating attribute image and for reconstructing the geometry images.

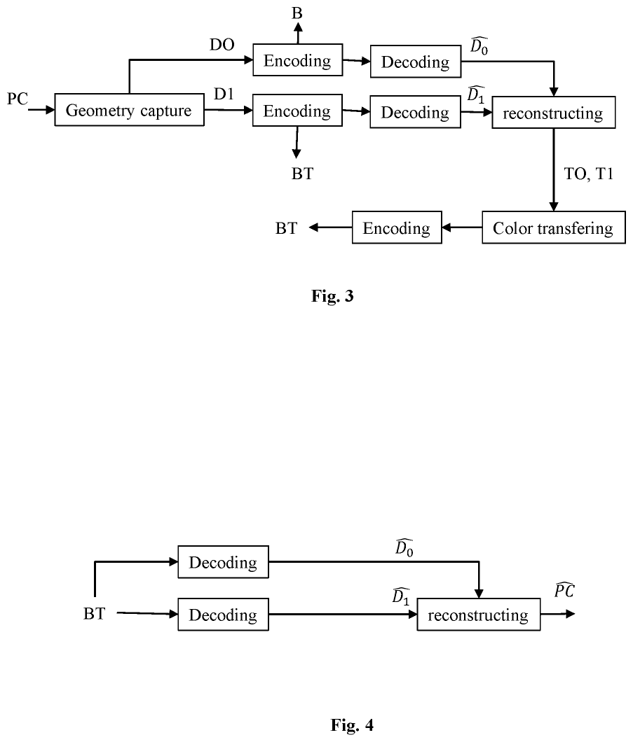

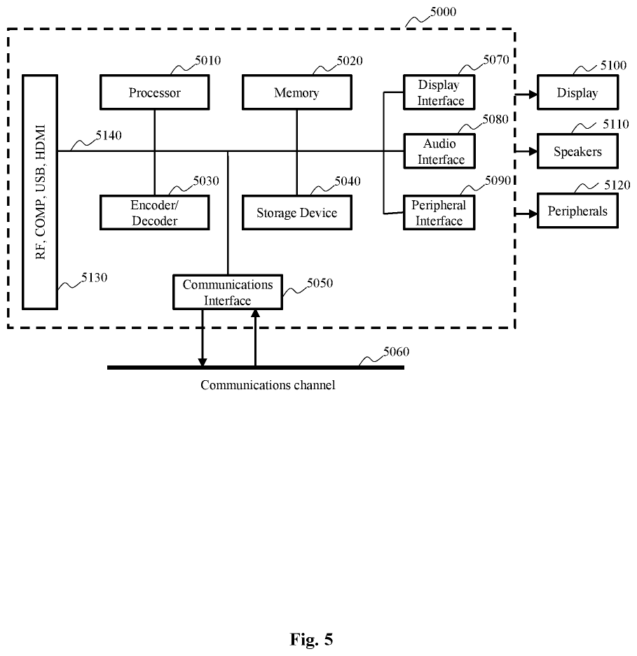

FIG. 4 shows schematically the method for decoding the geometry and attribute of a point cloud as defined TMC2.

A decoded first geometry image \hat{D}₀ and a decoded second geometry image \hat{D}₁ are obtained by decoding the bitstream BT. Possibly metadata are also decoded to reconstruct the geometry of the point cloud \hat{P}C.

The geometry of the point cloud is thus reconstructed by deprojection said decoded first and second geometry images and possibly said metadata.

The method 200 may also be used at the decoding side of TMC2 (FIG. 2 of Appendix A) when a reconstructed point cloud is required, i.e. when the geometry of the point cloud is/are required. This is the case, for example, for reconstructing the geometry of the point cloud.

On FIG. 1-8b, the modules are functional units, which may or not be in relation with distinguishable physical units. For example, these modules or some of them may be brought together in a unique component or circuit, or contribute to functionalities of a software. A contrario, some modules may potentially be composed of separate physical entities. The apparatus which are compatible with the present embodiments are implemented using either pure hardware, for example using dedicated hardware such ASIC or FPGA or VLSI, respectively «Application Specific Integrated Circuit», «Field-Programmable Gate Array», «Very Large Scale Integration», or from several integrated electronic components embedded in a device or from a blend of hardware and software components.

FIG. 5 illustrates a block diagram of an example of a system in which various aspects and embodiments are implemented. System 5000 can be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 5000, singly or in combination, can be embodied in a single integrated circuit, multiple ICs, and/or discrete components. For example, in at least one embodiment, the processing and encoder/decoder elements of system 5000 are distributed across multiple ICs and/or discrete components. In various embodiments, the system 5000 is communicatively coupled to other similar systems, or to other electronic devices, via, for example, a communications bus or through dedicated input and/or output ports. In various embodiments, the system 5000 is configured to implement one or more of the aspects described in this document.

The system 5000 includes at least one processor 5010 configured to execute instructions loaded therein for implementing, for example, the various aspects described in this document. Processor 5010 can include embedded memory, input output interface, and various other circuitries as known in the art. The system 5000 includes at least one memory 5020 (e.g., a volatile memory device, and/or a non-volatile memory device). System 5000 includes a storage device 5040, which can include non-volatile memory and/or volatile memory, including, but not limited to, EEPROM, ROM, PROM, RAM, DRAM, SRAM, flash, magnetic disk drive, and/or optical disk drive. The storage device 5040 can include an internal storage device, an attached storage device, and/or a network accessible storage device, as non-limiting examples. System 5000 includes an encoder/decoder module 5030 configured, for example, to process data to provide an encoded video or decoded video, and the encoder/decoder module 5030 can include its own processor and memory. The encoder/decoder module 5030 represents module(s) that can be included in a device to perform the encoding and/or decoding functions. As is known, a device can include one or both of the encoding and decoding modules. Additionally, encoder/decoder module 5030 can be implemented as a separate element of system 5000 or can be incorporated within processor 5010 as a combination of hardware and software as known to those skilled in the art.

Program code to be loaded onto processor 5010 or encoder/decoder 5030 to perform the various aspects described in this document can be stored in storage device 5040 and subsequently loaded onto memory 5020 for execution by processor 5010. In accordance with various embodiments, one or more of processor 5010, memory 5020, storage device 5040, and encoder/decoder module 5030 can store one or more of various items during the performance of the processes described in this document. Such stored items can include, but are not limited to, the input video, the decoded video, the point cloud, the reconstructed point cloud or portions of the decoded video, the bitstream, matrices, variables, and intermediate or final results from the processing of equations, formulas, operations, and operational logic.

In several embodiments, memory inside of the processor 5010 and/or the encoder/decoder module 5030 is used to store instructions and to provide working memory for processing that is needed during encoding or decoding.

In other embodiments, however, a memory external to the processing device (for example, the processing device can be either the processor 5010 or the encoder/decoder module 5030) is used for one or more of these functions. The external memory can be the memory 5020 and/or the storage device 5040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, VVC (Versatile Video Coding) or TMC2.

The input to the elements of system 5000 can be provided through various input devices as indicated in block 5130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 5130 have associated respective input processing elements as known in the art. For example, the RF portion can be associated with elements necessary for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband.

In one set-top box embodiment, the RF portion and its associated input processing element receives an RF signal transmitted over a wired (for example, cable) medium, and performs frequency selection by filtering, down-converting, and filtering again to a desired frequency band.

Various embodiments rearrange the order of the above-described (and other) elements, remove some of these elements, and/or add other elements performing similar or different functions.

Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 5000 to other electronic devices across USB and/or HDMI connections. It is to be understood that various aspects of input processing, for example, Reed-Solomon error correction, can be implemented, for example, within a separate input processing IC or within processor 5010 as necessary. Similarly, aspects of USB or HDMI interface processing can be implemented within separate interface ICs or within processor 5010 as necessary. The demodulated, error corrected, and demultiplexed stream is provided to various processing elements, including, for example, processor 5010, and encoder/decoder 5030 operating in combination with the memory and storage elements to process the data stream as necessary for presentation on an output device.

Various elements of system 5000 can be provided within an integrated housing. Within the integrated housing, the various elements can be interconnected and transmit data therebetween using suitable connection arrangement, for example, an internal bus as known in the art, including the I2C bus, wiring, and printed circuit boards.

The system 5000 includes communication interface 5050 that enables communication with other devices via communication channel 5060. The communication interface 5050 can include, but is not limited to, a transceiver configured to transmit and to receive data over communication channel 5060. The communication interface 5050 can include, but is not limited to, a modem or network card and the communication channel 5060 can be implemented, for example, within a wired and/or a wireless medium.

Data is streamed to the system 5000, in various embodiments, using a Wi-Fi network such as IEEE 802.11. The Wi-Fi signal of these embodiments is received over the communications channel 5060 and the communications interface 5050 which are adapted for Wi-Fi communications. The communications channel 5060 of these embodiments is typically connected to an access point or router that provides access to outside networks including the Internet for allowing streaming applications and other over-the-top communications.

Other embodiments provide streamed data to the system 5000 using a set-top box that delivers the data over the HDMI connection of the input block 5130.

Still other embodiments provide streamed data to the system 5000 using the RF connection of the input block 5130.

The streamed data may be used as a way for signaling information used by the system 5000. The signaling information may comprise the information data ID as explained above.

It is to be appreciated that signaling can be accomplished in a variety of ways. For example, one or more syntax elements, flags, and so forth are used to signal information to a corresponding decoder in various embodiments.

The system 5000 can provide an output signal to various output devices, including a display 5100, speakers 5110, and other peripheral devices 5120. The other peripheral devices 5120 include, in various examples of embodiments, one or more of a stand-alone DVR, a disk player, a stereo system, a lighting system, and other devices that provide a function based on the output of the system 5000.

In various embodiments, control signals are communicated between the system 5000 and the display 5100, speakers 5110, or other peripheral devices 5120 using signaling such as AV.Link, CEC, or other communications protocols that enable device-to-device control with or without user intervention.

The output devices can be communicatively coupled to system 5000 via dedicated connections through respective interfaces 5070, 5080, and 5090.

Alternatively, the output devices can be connected to system 5000 using the communications channel 5060 via the communications interface 5050. The display 5100 and speakers 5110 can be integrated in a single unit with the other components of system 5000 in an electronic device such as, for example, a television.

In various embodiments, the display interface 5070 includes a display driver, such as, for example, a timing controller (T Con) chip.

The display 5100 and speaker 5110 can alternatively be separate from one or more of the other components, for example, if the RF portion of input 5130 is part of a separate set-top box. In various embodiments in which the display 5100 and speakers 5110 are external components, the output signal can be provided via dedicated output connections, including, for example, HDMI ports, USB ports, or COMP outputs.

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and any other device for processing a picture or a video or other communication devices. As should be clear, the equipment may be mobile and even installed in a mobile vehicle.

Additionally, the methods may be implemented by instructions being performed by a processor, and such instructions (and/or data values produced by an implementation) may be stored on a computer readable storage medium. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present embodiments can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described example of the present embodiments, or to carry as data the actual syntax-values written by a described example of the present embodiments. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method, comprising encoding 3D points whose geometry is represented by geometry images and attribute is represented by an attribute image, wherein encoding 3D points comprises:
if the first depth value of a pixel in a first image of said geometry images and a second depth value of a co-located pixel in a second image of said geometry images are not the same, assigning to a co-located pixel of said attribute image, an attribute of a 3D point whose geometry is defined from 2D spatial coordinates of a co-located pixel in said first geometry image and the second depth value.

2. The method of claim 1, wherein the method further comprises assigning a dummy attribute to a pixel of said attribute image if the first depth value and the second depth value are the same.

3. The method of claim 1, wherein the dummy attribute is the attribute of the co-located pixel of another attribute image or the dummy attribute is an average of attributes associated with neighboring pixels located around said pixel.

4. (canceled)

5. The method of claim 1, wherein the method further comprises transmitting an information data indicating if the depth value of a pixel in said first geometry image and the depth value of a co-located pixel in said second geometry image are compared or not before reconstructing a 3D point from said geometry images.

6. The method of claim 5, wherein a bitstream carrying encoded attributes of 3D points being structured as multiples blocks, patches of blocks and frames of patches, wherein said information data is valid at a group of frame level, at frame level, at patch level or at block level.

7. A method, comprising
reconstructing a 3D point from 2D spatial coordinates of a pixel in a first geometry image and a first depth value of the pixel in said first geometry image,
if the first depth value and a second depth value of a co-located pixel in a second geometry image are not the same, reconstructing a 3D point from 2D spatial coordinates of the co-located pixel in the second geometry image and the second depth value.

8. The method of claim 7, wherein the method further comprises receiving an information data indicating if the depth value of a pixel in said first geometry image and the depth value of a co-located pixel in said second geometry image are compared or not before reconstructing a 3D point from said geometry images.

9. The method of claim 8, wherein a bitstream carrying encoded attributes of 3D points being structured as multiples blocks, patches of blocks and frames of patches, wherein said information data is valid at a group of frame level, at frame level, at patch level or at block level.

10. The method of claim 1, wherein an attribute of a 3D point is a color value or a texture value.

11. An apparatus for encoding 3D points whose geometry is represented by geometry images and attribute is represented by an attribute image, wherein the apparatus comprises a processor configured to:
if a first depth value of a pixel in a first image of said geometry images and a second depth value of a co-located pixel in a second image of said geometry images are not the same, assign to a co-located pixel in said attribute image, an attribute of a 3D point whose geometry is defined from 2D spatial coordinates of a co-located pixel in said first geometry image and the depth value of said co-located pixel in said second geometry image.

12. The apparatus of claim 11, wherein the method further comprises assigning a dummy attribute to a pixel of said attribute image if the first depth value and the second depth value are the same.

13. The apparatus of claim 12, wherein the dummy attribute is the attribute of the co-located pixel of another attribute image or the dummy attribute is an average of attributes associated with neighboring pixels located around said pixel.

14. (canceled)

15. The apparatus of claim 11, wherein the processor is further configured to transmitting an information data indicating if the depth value of a pixel in said first geometry image and the depth value of a co-located pixel in said second geometry image are compared or not before reconstructing a 3D point from said geometry images.

16. The apparatus of claim 15, wherein a bitstream carrying encoded attributes of 3D points being structured as multiples blocks, patches of blocks and frames of patches, wherein said information data is valid at a group of frame level, at frame level, at patch level or at block level.

17. An apparatus for reconstructing 3D points from geometry images representing the geometry of said 3D points, wherein the apparatus comprises a processor configured to:
reconstruct a 3D point from 2D spatial coordinates of a pixel in a first geometry image and a first depth value of the pixel in said first geometry image,
if the first depth value and a second depth value of a co-located pixel in a second geometry image are not the same, reconstruct a 3D point from 2D spatial coordinates of the co-located pixel in the second geometry image and the second depth value.

18. The apparatus of claim 17, wherein the processor is further configured to receiving an information data indicating if the depth value of a pixel in said first geometry image and the depth value of a co-located pixel in said second geometry image are compared or not before reconstructing a 3D point from said geometry images.

19. The apparatus of claim 18, wherein a bitstream carrying encoded attributes of 3D points being structured as multiples blocks, patches of blocks and frames of patches, wherein said information data is valid at a group of frame level, at frame level, at patch level or at block level.

20. The apparatus of claim 17, wherein an attribute of a 3D point is a color value or a texture value.

21. (canceled)

22. A non-transitory storage medium carrying instructions of program code for executing steps of the method according to claim 7, when said program is executed on a computing device.

23. A non-transitory storage medium carrying a bitstream carrying geometry and attributes images representing the geometry and attributes of 3D points, wherein the bitstream further carries an information data indicating if reconstructing a 3D point from said geometry and attributes images requires checking if a depth value of a pixel of a first of said geometry images and the depth value of a co-located pixel of a second of said geometry images are not the same before reconstructing a 3D point.
